(19) United States
(12) Patent Application Publication
(10) Pub. No.: US 2024/0020909 A1
(43) Pub. Date: Jan. 18, 2024

(54) IMAGE TEXTURE GENERATION METHOD BASED ON 3D SIMPLIFIED MODEL AND RELATED DEVICE

(71) Applicant: SHENZHEN UNIVERSITY, Shenzhen, Guangdong (CN)

(72) Inventors: Hui HUANG, Shenzhen (CN); Lingfeng CHEN, Shenzhen (CN)

(73) Assignee: SHENZHEN UNIVERSITY, Shenzhen, Guangdong (CN)

(21) Appl. No.: 18/296,712

(22) Filed: Apr. 6, 2023

(30) Foreign Application Priority Data
Jul. 18, 2022 (CN) 202210841604.3

(51) Int. Cl. G06T 15/04; G06T 17/20; G06T 19/20; G06T 5/50; G06T 5/00

(52) U.S. Cl. CPC G06T 15/04; G06T 17/205; G06T 19/20; G06T 5/50; G06T 5/006; G06T 2210/36; G06T 2219/2021

(57) ABSTRACT

An image texture generation method based on a 3D simplified model and a related device. In the embodiments, after planes are extracted from the simplified model, a group of optimal views need to be selected for each extracted plane. Then, it is necessary to align straight line features on the image. Finally, image stitching and texture optimizing are performed to generate a photo-level texture for the simplified model. The main processing object is city building. Compared with the prior art with a uniform mesh, the embodiments have the mesh with a higher degree of freedom, such that the straight line structure features of large-scale buildings can be aligned better, greatly reducing the storage and computing costs of 3D model of large city buildings and making the 3D simplified model have the visual effect comparable to that of the high-precision model.

### CROSS-REFERENCE TO RELATED APPLICATIONS

The present application claims priority to Chinese Patent Application No. 202210841604.3, filed on Jul. 18, 2022, the content of all of which is incorporated herein by reference

### TECHNICAL FIELD

The present application relates to the technical field of computer graphics, in particular to an image texture generation method and system based on a 3D simplified model, a terminal, and a computer-readable storage medium.

### BACKGROUND

With the development of 3D reconstruction technology and the rise of the concept of digital twin cities in recent years, 3D reconstruction technology has been widely used in large city reconstruction. 3D reconstruction model for large cities not only has a strong application value in reality, for example, being widely applied to unmanned driving and smart cities, but also profoundly influences the field of surveying and mapping.

However, in the actual application process, it has been found that the 3D reconstruction model for large cities always has the characteristics of huge scene scale, complex reconstruction structure, and extremely redundant surface mesh data, which makes it difficult to apply the reconstructed 3D model to various fields in real time. It is therefore crucial to simplify the 3D model. However, in the process of simplifying the 3D model, the texture information is usually ignored, where high-quality textures can greatly enhance the realism of 3D model and improve user experience. If the simplified model is capable of having ultra-realistic textures, the storage and computing overheads of the 3D model can be greatly reduced while visual effects are not lost.

In the traditional texture mapping methods, photo-level textures can be generated for 3D models, but because the texture mapping method relies heavily on the reconstruction quality of 3D model, currently there are only a few researches on texture mapping for simplified models. In the current research on simplified models, it is more inclined to generate textures using the texture synthesis method in which a generative adversarial network (GAN) is mainly involved. Such method is to define the building surface as a combination of elements such as roof, window, and door and to piece these elements together in proper positions through GAN. However, these textures are quite patterned and different from the surface of the original building, and thus lack realism.

In addition, textures can be also generated for 3D models using a surface reconstruction method based on structure from motion (SFM) and image superpixels. Through this method, streamlined object surfaces can be reconstructed quickly, but the generated object surfaces are still too redundant for buildings with obvious structural features. Furthermore, because of the use of per-vertex average coloring, the color in each triangle is the difference among the three vertex colors. As a result, the generated surface lacks texture details and reconstruction of photo-level textures is failed for the simplified model. In a method for simplified reconstruction of a photo-level indoor scene, the basic graphic elements of indoor scenes are extracted from the depth information obtained by the depth camera, and then the color information is mapped onto the plane. Such method can be used to filter redundant indoor scene information, and restore the geometric and texture information of the reconstruction result, with super-resolution. However, because the structure of the indoor scene has been preset, and there are too many loss functions to be optimized in the texture part, the application scene is limited and the convergence speed is too slow. The traditional texture mapping method based on triangular patches is only used to deal with the situation where the 3D model is almost identical to the real object in the photo. Therefore, none of these methods can be used to handle the special input of the simplified model that discards a lot of geometric details compared to the real object.

For city building, the surface has obvious straight line structure features, and the straight line structure features can be maintained well through the existing image stitching methods. For example, small local straight line features can be fused into global straight line features to ensure that the relationship between local straight lines remains unchanged after local deformation of the image. Large-scale global straight line features of buildings can be well aligned using such method.

With respect to the texture generation, the traditional texture mapping method based on triangular patches can be only used to deal with the situation where the 3D model is almost identical to the real object in the photo. Therefore, none of these methods can be used to handle the special input of the simplified model that discards a lot of geometric details compared to the real object. Moreover, because the basic unit is a small triangular patch, it is difficult to optimize the straight line structure features of surface on the large-scale building. In addition, according to the current texture generation method for simplified models, preset building elements are used, such as doors and windows, to generate textures for simplified models, but these textures are patterned and lack realism.

In terms of image stitching, the current image stitching method is to use a uniform mesh during local fine-tuning through image deformation. In addition, controlling a straight line for alignment may require coordinated control of multiple meshes, and after deformation, it cannot be guaranteed that straight line features remain straight.

Therefore, the prior art still needs to be improved and developed.

### SUMMARY

A main objective of the present application is to provide an image texture generation method and system based on a 3D simplified model, a terminal, and a computer-readable storage medium, so as to resolve the problem in the related art that the 3D simplified model lacks realism and has high storage and computing overheads.

To achieve the foregoing objective, the present application provides an image texture generation method based on a 3D simplified model, including the following steps:
obtaining a 3D simplified model, performing surface subdivision processing on the 3D simplified model, and converting a plane in the 3D simplified model into dense triangular patches, where the triangular patch is taken as a basic unit of the plane;
selecting a group of candidate views for each plane, calculating view quality of each candidate view of each plane under a current condition using greedy algorithm, and selecting out locally optimal views after sorting, so as to generate an optimal view set;
selecting a view with the highest quality as a target image from the optimal view set of each plane, where the other views serve as source images, calculating a homography matrix H from the source image to the target image, performing view distortion on the source image through the homography matrix, and transforming the source image into a camera space of the target image, so as to generate a rough result of image stitching;
extracting straight line features from the source image and target image and matching the straight line features, and performing local fine-tuning on the source image via an adaptive mesh, so as to align the straight line features; and
controlling image distortion using the adaptive mesh, performing graph cutting and Poisson editing to mix the images after the source images are distorted, eliminating seams in image stitching, and performing image stitching and texture optimizing to generate a photo-level texture for the 3D simplified model.

After the obtaining a 3D simplified model, performing surface subdivision processing on the 3D simplified model, and converting a plane in the 3D simplified model into dense triangular patches, where the triangular patch is taken as a basic unit of the plane, the image texture generation method based on a 3D simplified model further includes:

if a single triangular patch satisfies any one of preset conditions, considering that the triangular patch is invisible in view, and filtering out the invisible triangular patch, where the preset conditions include:
that only a back of a triangular patch is visible in view;
that an angle between a vector from a center of a triangular patch to a view and a patch normal vector is greater than 75 degrees;
that a triangular patch exceeds an image boundary after being projected into the image space;
that a triangular patch occludes a simplified model in view; and
that a triangular patch occludes a dense model in view.

In the image texture generation method based on a 3D simplified model, where the selecting a group of candidate views for each plane, calculating view quality of each candidate view of each plane under a current condition using greedy algorithm, and selecting out locally optimal views after sorting, so as to generate an optimal view set includes:
calculating a photometric consistency coefficient for each candidate view using a mean shift method, calculating an average color value of each candidate view after filtering, finding a mean and covariance of the average color values of the views, calculating a consistency value of each view using a multivariate Gaussian kernel function, and deleting the view of which the consistency value is lower than a first preset size from the candidate views until a maximum covariance of the average color values is lower than a second preset size;
taking the remaining candidate views as a group of views with the highest consistency, and computing a photometric consistency value for each view of the plane according to a mean and covariance of the views with the highest consistency, where a larger photometric consistency value represents a higher photometric consistency of view; and
the view quality is calculated according to the following equation:

G( [symbol] ᵢ, [symbol] ᵢ^{t})=D( [symbol] ᵢ, [symbol] ᵢ^{t})·C( [symbol] ᵢ, [symbol] ᵢ^{t})·N( [symbol] ᵢ, [symbol] ᵢ^{t}); where

D( [symbol] ᵢ, [symbol] ᵢ^{t}) represents an average gradient magnitude; C( [symbol] ᵢ, [symbol] ᵢ^{t}) represents a photometric consistency coefficient; N( [symbol] ᵢ, Mᵢ^{t}) represents an angle between a sight line and a normal line; [symbol] ᵢ represents each view; and [symbol] ᵢ^{t} represents a region covered by a specified color boundary in each texture block; and
according to view quality of each view, selecting out the locally optimal views after sorting, so as to generate the optimal view set.

In the image texture generation method based on a 3D simplified model, information considered when the view quality is calculated includes: view clarity, photometric consistency, angle between a plane and a sight line, and completeness of plane texture information contained by a view.

In the image texture generation method based on a 3D simplified model, the extracting straight line features from the source image and target image and matching the straight line features, and performing local fine-tuning on the source image via an adaptive mesh, so as to align the straight line features includes:
extracting a plurality of local straight line features from the source image and target image, filtering out small and dense straight lines, and fusing local straight line features into global straight line features;
comparing the global straight line features of the source image and the target image, and when an angle between candidate straight lines for matching and a distance from an endpoint to the straight line are less than set thresholds, considering that two straight lines match; and
triangulating the global straight line features to generate an adaptive mesh based on straight line features for all views in the plane, and using the adaptive mesh to perform local fine-tuning on the images.

In the image texture generation method based on a 3D simplified model, the steps of controlling image distortion using the adaptive mesh, and performing graph cutting and Poisson editing to mix the images after the source images are distorted include:
setting the adaptive mesh as an adaptive triangular mesh;
controlling distortion of the adaptive triangular mesh using the following energy equation:

E(\hat{V})=λₐEₐ(\hat{V})+λₗEₗ(\hat{V})+λᵣE^{r}(\hat{V}); where

\hat{V} represents a vertex position of the distorted adaptive triangular mesh; Eₐ(\hat{V}) represents an alignment item for a straight line feature, which is used to show a moving distance of the vertex \hat{V}; Eₜ(\hat{V}) represents a straight line feature reservation item, which is used to ensure linearity of the straight line feature before and after image distortion; Eᵣ(\hat{V}) represents a regular term, which is used to prevent an offset of the vertex from being excessively large; and λₐ, λₗ, and λᵣ represent weights of Eₐ(\hat{V}), Eₗ(\hat{V}), and Eᵣ(\hat{V}) respectively;
substituting points of the adaptive mesh of the source image into a straight line equation of a matched target image, to obtain an alignment error of matched straight lines between the source image and the target image, where straight line equation is as follows:

$${E}_{a} ( \hat{V} ) = {\sum }_{t = 1}^{M} {‖ {a}_{t} \hat{x} + {b}_{t} \hat{y} - {c}_{t} ‖}^{2} = {‖ {W}_{a} \hat{V} ‖}^{2} ;$$

where
\hat{x} and ŷ represent vertex coordinates; aₜ, bₜ, and cₜ represent three parameters of the straight line equation; M represents a quantity of matched straight-line pairs; and Wₐ represents a matrix; and
for all segmented straight line features, Eₗ(\hat{V}) is expressed using the following equation:

Eₗ(\hat{V})=Σ_{g=1}^{N}Σₖ₌₁^{J}^{_{g}}⁻¹∥((\hat{p}_{k÷1}^{g})−(\hat{p}ₖ^{g}))·\vec{n}^{g}∥²=∥Wₗ\hat{V}∥²; where

where

N represents a quantity of segmented global straight lines; J_{g} represents a quantity of points on a global straight line; g represents g th matched straight line feature; k represents a k th point on a global straight line; \vec{n}^{g} represents a normal vector of a global line; and Wₗ represents a coefficient in matrix form; and
traversing all triangular patches in the adaptive triangular mesh, calculating an affine transformation matrix of distorted triangular patches for triangular patches before distortion, performing affine transformation on an image region in which the triangular patches are located, stitching all transformed triangular image fragments into a new image, and mixing the distorted new image with the target image through graph cutting and Poisson editing.

In the image texture generation method based on a 3D simplified model, the texture optimizing includes:
for a texture block of each source image, extracting an overlapping region between the texture block of each source image and a target texture block; and
transforming an overlapping region of target texture blocks as well as the texture block of the entire source image into an HSV space, calculating a histogram distribution for a v channel, performing histogram matching between a v channel of the source image and a v channel of the overlapping region of the target regions, and transferring a luminance distribution of the overlapping region to the texture block of the entire source image.

In addition, to achieve the foregoing objective, the present application further provides an image texture generation system based on a 3D simplified model, including:
a plane conversion module, configured to obtain a 3D simplified model, perform surface subdivision processing on the 3D simplified model, and convert a plane in the 3D simplified model into dense triangular patches, where the triangular patch is taken as a basic unit of the plane;
a view selection module, configured to select a group of candidate views for each plane, calculate view quality of each candidate view of each plane under a current condition using greedy algorithm, and select out locally optimal views after sorting, to generate an optimal view set;
a pre-alignment module configured to select a view with the highest quality as a target image from the optimal view set of each plane, where the other views serve as source images, calculate a homography matrix H from the source image to the target image, perform view distortion on the source image through the homography matrix, and transform the source image into a camera space of the target image, so as to generate a rough result of image stitching;
a module for extracting and matching straight line features, configured to extract straight line features from the source image and target image and match the straight line features, and perform local fine-tuning on the source image via an adaptive mesh, so as to align straight line features; and
an image-stitching and texture-optimizing module, configured to control image distortion using the adaptive mesh, perform graph cutting and Poisson editing to mix the images after the source images are distorted, eliminate seams in image stitching, and perform image stitching and texture optimizing to generate a photo-level texture for the 3D simplified model.

Additionally, to achieve the foregoing objective, the present application further provides a terminal. The terminal includes: a memory, a processor, and an image texture generation program based on a 3D simplified model, the image texture generation program being stored on the memory, capable of running on the processor, where when the image texture generation program based on a 3D simplified model is executed by the processor, the steps of the image texture generation method based on a 3D simplified model are implemented.

In addition, to achieve the foregoing objective, the present application further provides a computer-readable storage medium. The computer-readable storage medium stores an image texture generation program based on a 3D simplified model, where when the image texture generation program based on a 3D simplified model is executed by the processor, the steps of the image texture generation method based on a 3D simplified model are implemented.

In the present application, the image texture generation method based on a 3D simplified model includes: obtaining a 3D simplified model, performing surface subdivision processing on the 3D simplified model, and converting a plane in the 3D simplified model into dense triangular patches, where the triangular patch is taken as a basic unit of the plane; selecting a group of candidate views for each plane, calculating view quality of each candidate view of each plane under a current condition using greedy algorithm, and selecting out locally optimal views after sorting, so as to generate an optimal view set; selecting a view with the highest quality as a target image from the optimal view set of each plane, where the other views serve as source images, calculating a homography matrix H from the source image to the target image, performing view distortion on the source image through the homography matrix, and transforming the source image into a camera space of the target image, so as to generate a rough result of image stitching; triangular patch extracting straight line features from the source image and target image and matching the straight line features, and performing local fine-tuning on the source image via an adaptive mesh, so as to align the straight line features; and controlling image distortion using the adaptive mesh, performing graph cutting and Poisson editing to mix the images after the source images are distorted, eliminating seams in image stitching, and performing image stitching and texture optimizing to generate a photo-level texture for the 3D simplified model. In the present application, after planes are extracted from the simplified model, a group of optimal views need to be selected for each extracted plane. Then, it is necessary to align straight line features on the image. Finally, image stitching and texture optimizing are performed to generate a photo-level texture for the simplified model.

### BRIEF DESCRIPTION OF THE DRAWINGS

FIG. 1 is a flowchart of an embodiment of an image texture generation method based on a 3D simplified model according to the present application;

FIG. 2 is a frame diagram of an overall processing procedure in an embodiment of an image texture generation method based on a 3D simplified model according to the present application;

FIG. 3 is a schematic diagram of a process of selecting views in an embodiment of an image texture generation method based on a 3D simplified model according to the present application;

FIG. 4 is a schematic diagram in which triangular patches occlude a simplified model and a dense model in an embodiment of an image texture generation method based on a 3D simplified model according to the present application;

FIG. 5 is a schematic diagram of a visible view filtering result in an embodiment of an image texture generation method based on a 3D simplified model according to the present application;

FIG. 6 is a schematic diagram of image selection in an embodiment of an image texture generation method based on a 3D simplified model according to the present application;

FIG. 7 is a schematic diagram of pre-alignment in an embodiment of an image texture generation method based on a 3D simplified model according to the present application;

FIG. 8 is a schematic diagram of straight line feature matching in an embodiment of an image texture generation method based on a 3D simplified model according to the present application;

FIG. 9 is a schematic diagram of an adaptive mesh based on straight line features in an embodiment of an image texture generation method based on a 3D simplified model according to the present application;

FIG. 10 is a schematic diagram of results of texture restoration and photometric consistency optimization in an embodiment of an image texture generation method based on a 3D simplified model according to the present application;

FIG. 11 is a schematic diagram in an embodiment of a texture comparison result of three methods in an embodiment of an image texture generation method based on a 3D simplified model according to the present application;

FIG. 12 is a schematic diagram in an embodiment of an image texture generation system based on a 3D simplified model according to the present application; and

FIG. 13 is a schematic diagram of an operating environment in an embodiment of the terminal according to the present application.

### DETAILED DESCRIPTION OF THE EMBODIMENTS

To make the objective, technical solution, and advantages of the present application clearer, the present application will be further described in detail below with reference to the accompanying drawings and embodiments. It should be understood that the specific embodiments described herein are only used to explain the present application rather than limit the present application.

The technical problem to be resolved by the present application is how a highly realistic texture is generated based on inputted photos for a simplified model without texture information. Different from the previous texture mapping method based on triangular patches that requires high model accuracy, the present application requires a plane as the basic unit to generate a texture for the simplified model to ensure that straight line structure features of large-scale buildings can be aligned. After planes are extracted from the simplified model, a group of optimal views need to be selected for each extracted plane. Then, it is necessary to align straight line features on the image. Finally, image stitching and texture optimizing are performed to generate a photo-level texture for the simplified model. In this way, the storage and computing overheads of 3D models for city buildings are minimized while high realism remains.

The objectives of the present application are to generate high-realistic textures for the 3D simplified model of city buildings based on inputted photos, greatly reduce the storage and computing costs of the 3D models of large city buildings, and let the 3D simplified model have the visual effect comparable to that of the high-precision model. For the simplified model of city buildings with obvious plane structure features, the plane and its outline are first extracted from such model, and then a group of optimal views are selected for the model with the plane as the basic unit. Views are scored from multiple dimensions for selection, which is then performed using a greedy strategy. The view with the highest score is used as the target view. It is guaranteed that a complete texture can be assembled for each plane with fewest views, and these views are clear and photometrically consistent.

After the view is selected, it is necessary to unify the source views into the image space of the target view, and to use the previously extracted plane information to perform homography transformation on the source views, so as to transform the source views into such space. Because the difference between the simplified model and the high-precision model may cause the straight line features in the local region on the plane to be misaligned, it is necessary to locally fine-tune the source view to align these linear features. The straight lines are aligned by maintaining straight line features and stitching aligned images. In comparison with the previous image stitching method with the uniform mesh used, in the present application, an adaptive mesh is proposed to control the image distortion, and the straight lines can be controlled more flexibly to be aligned. After the source images are distorted, graph cutting and Poisson editing are performed to mix images. The seams in the image stitching are eliminated. Finally, generated textures are optimized, and are restored through histogram matching and PatchMatch based on the straight line features, and photometric inconsistencies between views and texture holes caused by imperfect views acquisition are eliminated.

The present application mainly includes view selection and image stitching for planar structures. The pictures and camera parameters are derived from photos taken by drones and commercial software RealityCapture, and the simplified model comes from the simplified reconstruction results. The view selection mainly includes visibility filtering and image selection. The image stitching mainly includes pre-alignment, adaptive mesh-based image stitching, and texture optimizing.

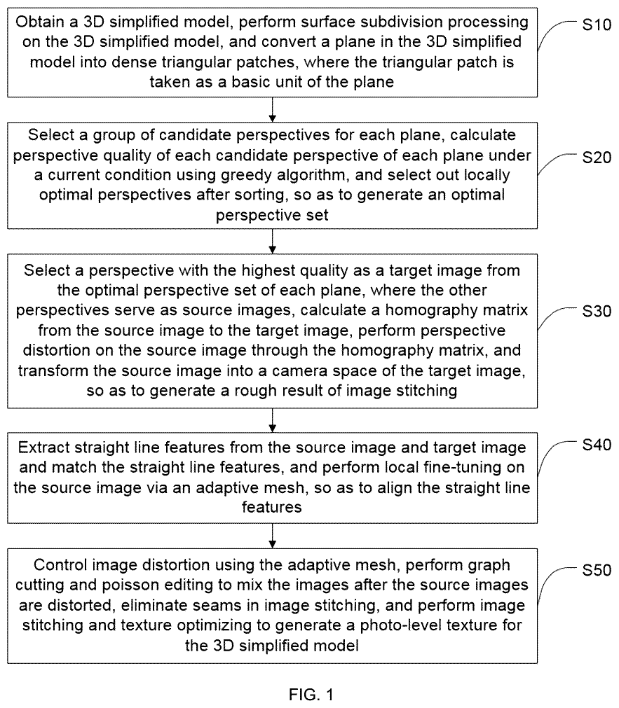

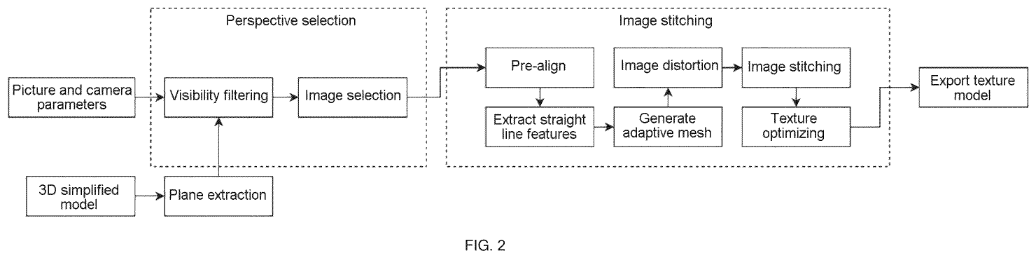

An image texture generation method based on a 3D simplified model described in an embodiment of the present application is shown in FIG. 1 and FIG. 2, including the following steps:

Steps S10: Obtain a 3D simplified model, perform surface subdivision processing on the 3D simplified model, and convert a plane in the 3D simplified model into dense triangular patches, where the triangular patch is taken as a basic unit of the plane.

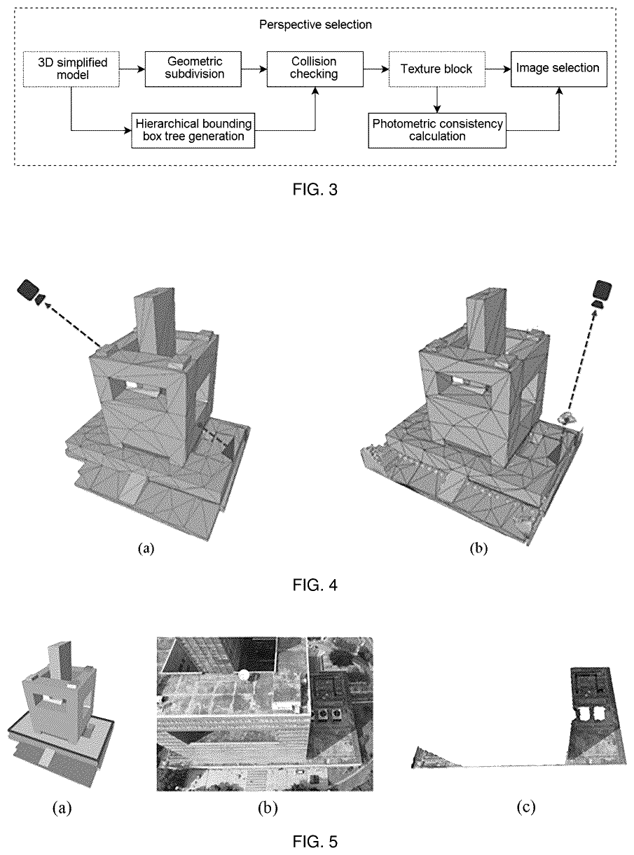

As shown in FIG. 3, for a 3D simplified model with an obvious planar structure, compared with the previous texture mapping method based on triangular patches, the method of the present application is to use a plane as the basic unit for texture mapping. For each plane, it is necessary to select a group of optimal view for texture synthesis. Planes on the 3D simplified model need to be subdivided, and the planes are converted into dense triangular patches, where the triangular patch is used as a basic unit of plane. For each candidate view, the texture information of the plane needs to be filtered out from the picture, which requires visibility filtering. It is considered that a triangular patch is invisible in this view, if it satisfies the following five conditions:
(1) Only a back of a triangular patch is visible in this view.
(2) An angle between a vector from a center of a triangular patch to a view and a patch normal vector is greater than 75 degrees.
(3) A triangular patch exceeds an image boundary after being projected into the image space.
(4) A triangular patch occludes the simplified model in this view.
(5) A triangular patch occludes the dense model in this view.

The condition (5) is optional. If it occurs, the simplified triangular mesh of the dense model is removed from the image; the occluded patch is deleted from the image by performing collision detection on the hierarchical bounding box tree of the 3D simplified model.

After the visibility filtering of the triangular patch, the average pixel gradient magnitude of the visible part is calculated in this view. A larger gradient magnitude indicates a clearer view and a smaller area of motion blur, and therefore the quality of this view is higher. The final filtering result is shown in FIG. 4: for each plane, the invisible part in this view is deleted.

Step S20: Select a group of candidate views for each plane, calculate view quality of each candidate view of each plane under a current condition using greedy algorithm, and select out locally optimal views after sorting, so as to generate an optimal view set.

As shown in FIG. 5, after the group of candidate views are selected for each plane, to exclude views, such as those far brighter or darker than other views, that are too different from most views, it is necessary to calculate the photometric consistency coefficient for the visible part of each view to penalize (it is less inclined to select these views with lower quality indicated by smaller photometric consistency coefficients) these views. In the present application, a photometric consistency coefficient is calculated for each candidate view using a mean shift method. An average color value of each candidate view is first calculated after filtering, a mean and covariance of the average color values of the views are then found, a consistency value of each view is next calculated using a multivariate Gaussian kernel function, and finally, the view of which the consistency value is lower than a first preset size (for example, the first preset size is 6·1⁻³) is deleted from the candidate views. Such process is repeated until a maximum covariance of the average color values is lower than a second preset size (for example, the second preset size is 5·10⁻⁴). The last remaining candidate views form a group of views with the highest consistency. According to the mean and covariance of this group of views, a photometric consistency value is calculated for each view of the plane. A larger photometric consistency value indicates a higher photometric consistency. The quality of last view is calculated according to the following equation:

G( [symbol] ᵢ, [symbol] ᵢ^{t})=D( [symbol] ᵢ, [symbol] ᵢ^{l})·C( [symbol] ᵢ, [symbol] ᵢ^{t})·N( [symbol] ᵢ, [symbol] ᵢ^{l}); where

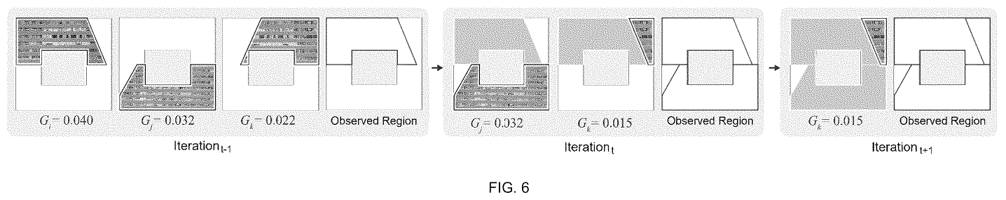

D( [symbol] ᵢ, [symbol] ₗ^{t}) represents an average gradient magnitude; C( [symbol] ᵢ, [symbol] ᵢ^{t}) represents a photometric consistency coefficient; N( [symbol] ᵢ, [symbol] ₗ^{t}) represents an angle between a sight line and a normal line; [symbol] ᵢ represents each view (For example, a texture block above Gi in FIG. 6); and [symbol] ᵢ^{t} represents a region covered by a specified color (for example, blue in reality) boundary in each texture block.

In the view quality calculation method, the following are considered: view clarity, photometric consistency, angle between a plane and a sight line, and completeness of plane texture information contained by a view, such that views with higher quality can be selected in the next step. According to view quality of each view, the locally optimal views are selected out after sorting, so as to generate the optimal view set.

In the present application, the greedy algorithm is used. The view quality under the current condition is calculated for each view, and locally optimal views are selected after sorting. Then, the scores of the remaining views are updated, and optimal views are selected in the next iteration until the visible part of the plane is covered. In FIG. 6, through the greedy algorithm, the score of the blue (actually blue) boundary region in each texture block is calculated, and the region with the highest score is selected. It can be seen that it occupies the red (actually red) part of the observed region (region). The red part is subtracted from other texture blocks and the score is updated. Then, the one with the highest score is selected, and this process is repeated until all the parts that can be seen have texture.

In the previous step, the group of views that are most suitable for image stitching are obtained for each plane. These views meet the requirements of clarity and high photometric consistency, and the overlapping area between views is small. Next, these views need to be stitched into a complete texture. The following describes how to stitch, through pre-alignment and adaptive mesh, a texture with multi-view straight line features aligned with each other for a plane while keeping the straight line properties unchanged.

Step S30: Select a view with the highest quality as a target image from the optimal view set of each plane, where the other views serve as source images, calculate a homography matrix H from the source image to the target image, perform view distortion on the source image through the homography matrix, and transform the source image into a camera space of the target image, so as to generate a rough result of image stitching.

The plane and polygons (such as triangles) of the 3D simplified model have been extracted, the vertices of the polygons are projected into the image space through the camera pose, and the position of the same point in the 3D space in different images can be obtained. With the camera poses used, the process of finding and matching feature points in the conventional image stitching method is eliminated.

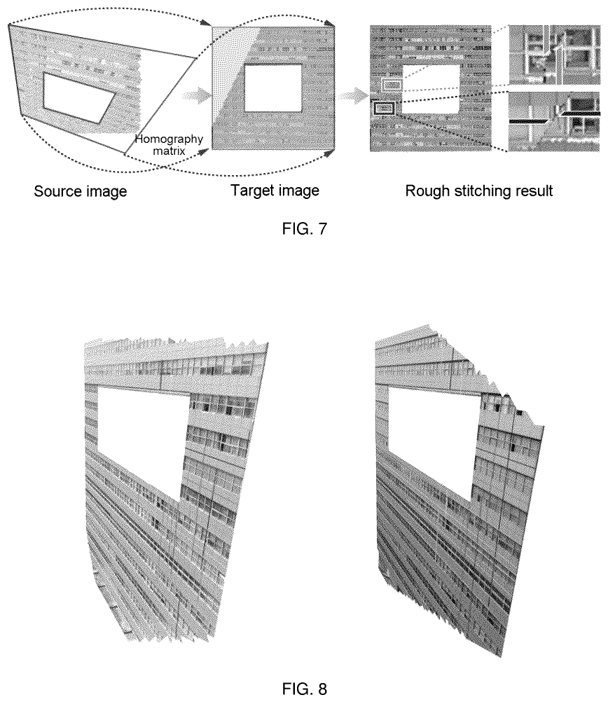

The pre-alignment process is shown in FIG. 7. A view with the highest quality is selected as a target image from the optimal view set of each plane, where the other views serve as source images. A homography matrix H from the source image to the target image is calculated. View distortion is performed on the source image through the homography matrix H, so as to transform the source image into a camera space of the target image.

However, in the process of structural reconstruction of the 3D simplified model, its 3D vertices have offsets from the real building, and there is an error in the camera parameters. As a result, the edges and points in the 3D space cannot be accurately mapped to those on the image. But in general, these errors are relatively small and cause only some small errors in the stitching result, so this information can be used to generate a rough initial result. The rough result is locally fine-tuned later according to the geometric characteristics of the image.

Step S40: Extract straight line features from the source image and target image and match the straight line features, and perform local fine-tuning on the source image via an adaptive mesh, so as to align the straight line features.

The rough result, of image stitching, generated through pre-alignment provides a relatively good initial value, but fails to have the geometric features for completely aligning two images in detail. Therefore, straight line features need to be extracted from the source image and target image for matching, and the source image is locally fine-tuned via an adaptive mesh, so as to align the straight line features.

First, straight line features need to be extracted from the images. In the present application, a plurality of local straight line features are extracted from two images, small and dense straight lines are filtered out, and local straight line features are fused into global straight line features.

For the extracted local straight line feature set, a pairwise comparison is made for each of the straight lines, and there are three conditions for the fusion of two straight lines:
(1) Slopes of two lines should be close enough.
(2) A distance between endpoints of two straight lines and a straight line should be small enough.
(3) A distance between adjacent endpoints of two straight lines should be small enough.

After the straight lines are fused into global straight lines, for alignment of the straight line features between different images, the straight lines need to be matched first. After the straight line is transformed, the straight line features of the source image and the target image are very close, so the line features in two images are simply compared two by two, and for each straight line, a straight line with the closest slope and the smallest distance from the end point to the straight line is selected as the matching straight line. When the angle between the candidate matching straight lines and the distance from the endpoint to the straight line are less than set thresholds, it is considered that the two straight lines are matched. FIG. 8 shows that the matching result of straight lines between the source image and the target image is relatively correct.

In all existing image stitching methods, the image is distorted using uniform mesh, so as to locally fine-tune image. In the field of face recognition, face features are usually triangulated. This triangular mesh based on face features is indispensable for face recognition, fusion, and face changing. Based on such concept, in the present application, the global straight line features are triangulated to generate an adaptive mesh based on straight line features for all views in the plane, and the adaptive mesh is used to perform local fine-tuning on the images.

Step S50: Control image distortion using the adaptive mesh, perform graph cutting and Poisson editing to mix the images after the source images are distorted, eliminate seams in image stitching, and perform image stitching and texture optimizing to generate a photo-level texture for the 3D simplified model.

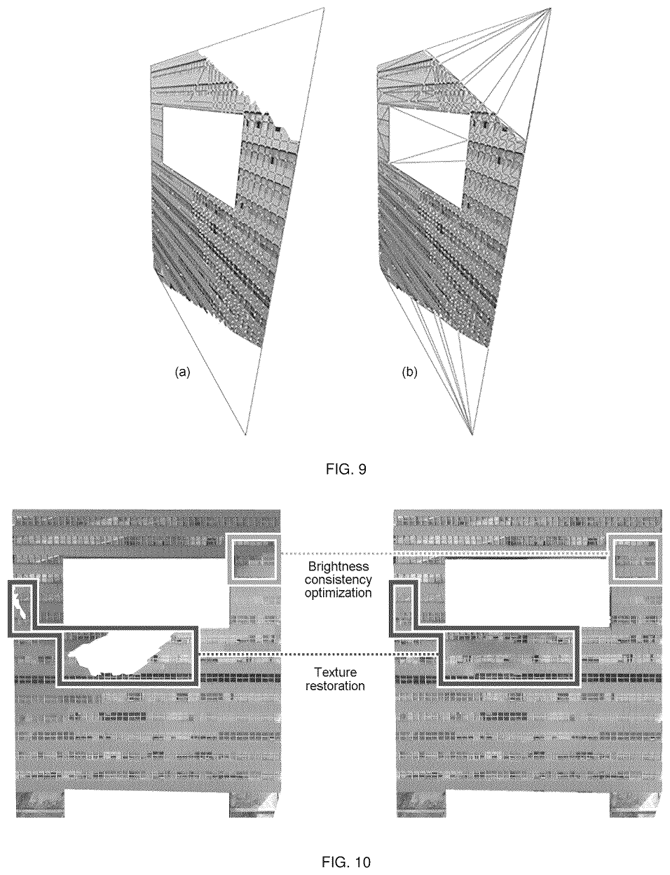

Because the straight line features, when triangulated, cannot be intersected, the global straight line features need to be preprocessed before triangulation. For each straight line, it is calculated whether there is an intersection point between a straight line feature and another straight line feature. If there is, the point is inserted in an orderly manner according to its distance from the starting point of the straight line. The detection result of the straight line intersection point is shown in FIG. 9 (a). For the segmented global straight line features, constrained Delaunay triangulation is used to generate a triangular mesh: with straight line features and polygons as constraints, the triangulation process is limited to polygons. The result of triangulation is shown in (b) of FIG. 9. It can be seen that the generated result of the constrained Delaunay triangulation is not a complete Delaunay triangular mesh, and some triangles do not satisfy the empty circle characteristic, but they can be aligned with the straight line features of the image.

After the adaptive triangular mesh is generated, the image is locally fine-tuned by deforming the triangular mesh. When the source image is distorted, it is necessary to ensure not only that its straight line features are aligned with the target image, but also that its straight line features remain linear. Distortion of the adaptive triangular mesh is controlled using the following energy equation:

E(\hat{V})=λₐEₐ(\hat{V})+λₗEₗ(\hat{V})+λᵣEᵣ(\hat{V}); (1) where

\hat{V} represents a vertex position of the distorted adaptive triangular mesh; Eₐ(\hat{V}) represents an alignment item for a straight line feature, which is used to show a moving distance of the vertex (\hat{V}); Eₗ(\hat{V}) represents a straight line feature reservation item, which is used to ensure linearity of the straight line feature before and after image distortion; Eᵣ(\hat{V}) represents a regular term, which is used to prevent an offset of the vertex from being excessively large; and λₐ, λₗ, and λᵣ represent weights of Eₐ(\hat{V}), Eₗ(\hat{V}), and Eᵣ(\hat{V}) respectively and are expressed as floating points, where a larger λₐ indicates a more important Eₐ(\hat{V}) and it is more inclined to align matched straight lines.

Points of the adaptive mesh of the source image are substituted into a straight line equation of a matched target image, to obtain an alignment error of matched straight lines between the source image and the target image, where straight line equation is as follows:

$${E}_{a} ( \hat{V} ) = {\sum }_{t = 1}^{M} {‖ {a}_{t} \hat{x} + {b}_{t} \hat{y} - {c}_{t} ‖}^{2} = {‖ {W}_{a} \hat{V} ‖}^{2} ;$$

(2) where

\hat{x} and ŷ represents vertex coordinates; aₜ, bₜ, and cₜ represent three parameters of the straight line equation; M represents a quantity of matched straight-line pairs; and Wₐ represents a matrix.

When the straight line features are pre-processed, some global straight lines are segmented into multiple short straight lines. For the segmented global straight line features, it must be ensured that all segmentation points on the global straight line features are collinear before and after image distortion. For all segmented line features, the specific form of Eₗ(\hat{V}) is as follows:

Eₗ(\hat{V})=Σ_{g=1}^{N}Σₖ₌₁^{J}^{_{g}}⁻¹∥((\hat{p}ₖ₊₁^{g})−(\hat{p}ₖ^{g}))·\vec{n}^{g}∥²=∥Wₗ\hat{V}∥²; (3) where

N represents a quantity of segmented global straight lines (the unsegmented global straight lines can guarantee linearity); J_{g} represents a quantity of points on a global straight line; g represents a g th matched straight line feature; k represents a k th point on a global straight line; \vec{n}^{g} represents a normal vector of a global straight line; Wₗ and represents a coefficient in matrix form.

Equation (3) represents that in the adaptive mesh of the source image, for the collinearity of the segmentation points on the global straight lines, the vectors formed by all segmentation points and adjacent points need to maintain an orthogonal relationship with the normal vectors of the global straight lines. Equations (2) and (3) are constructed into matrix forms, which are resolved using the linear solver Eigen. After an offset is obtained for each vertex, all triangular patches are traversed in the adaptive mesh, an affine transformation matrix of distorted triangular patches is calculated for triangular patches before distortion, affine transformation is performed on an image region in which the triangular patches are located, all transformed triangular image fragments are stitched into a new image, and the distorted new image is mixed with the target image through graph cutting and Poisson editing in the present application.

In the process of texture mapping, problems occurred during view collection may cause some regions in the plane without any view to have some texture information, and different lighting conditions between different views lead to the inconsistency of the photometric between the texture blocks, which cause serious distortion of the textures.

To solve the problem of photometric inconsistency between different viewing angles, the present application assumes that textures belonging to the same plane should have the same luminance distribution, and optimizes the photometric consistency of texture blocks from all views. For the texture block of each source image, its overlapping region with the target texture block is extracted. An overlapping region of target texture blocks as well as the texture block of the entire source image are transformed into an HSV space, a histogram distribution is calculated for a v channel, histogram matching is performed between a v channel of the source image and a v channel of the overlapping region of the target regions, and a luminance distribution of the overlapping region is transferred to the texture block of the entire source image.

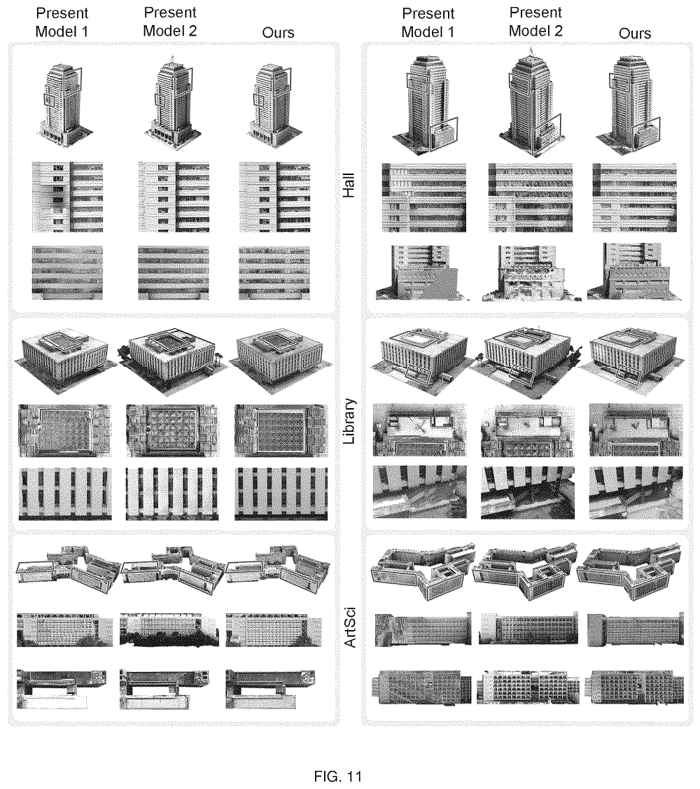

In terms of texture restoration, image restoration is guided through the linear features extracted above. In the present application, a texture is generated for a single plane, and the processing object is the city building, whose surface has obvious features of orthogonal straight lines. Therefore, the main direction is replaced with the main direction of the extracted two groups of orthogonal straight line features, and then the propagation mechanism of PatchMatch is used to guide the image restoration. The final results of texture restoration and photometric consistency optimization are shown in FIG. 10.

In the present application, a texture mapping method based on a planar structure is proposed to generate textures with a high sense of reality for a structured model by aligning large-scale straight-line structure features, allowing the 3D simplified model to have visual effects comparable to that of the high-precision model while greatly reducing storage and computing overheads. The present application provides a view selection method based on a planar structure. In this method, a texture is stitched as complete as possible with fewest views. In addition, the present application provides an image stitching method based on an adaptive mesh, such that straight line features on the plane of city buildings can be aligned better.

The present application has been tested in multiple scenarios, and FIG. 11 shows a comparison result between high-precision models with textures reconstructed by LTBC (present model 1) and RC (present model 2). Compared with texture result of LTBC, the texture result generated by the present application shows that fewer seams are present, that straight line features of buildings are aligned, and that the photometric of texture blocks with different views on the same plane are also more consistent.

It can be seen that the texture result of the present application is close to that of the high-precision model. In the present application, for the region not captured in the photo, the texture is restored, and the texture effect on these regions is visually better than LTBC and high-precision models.

TABLE 1
Comparison of storage overhead

| | | Plane | Model | Texture size |
|---|---|---|---|---|
| Scenario | Method | number | size (Mb) | (Mb) |
| Hall | RC | 2,999,999 | 383 | 230 |
| | LTBC | 156,006 | 14.50 | 326 |
| | Our | 876 | 0.04 | 54 |
| Library | RC | 4,000,000 | 433 | 86 |
| | LTBC | 90,098 | 9.18 | 264 |
| | Our | 207 | 0.01 | 53 |
| ArtSci | RC | 8,278,218 | 980 | 360 |
| | LTBC | 66,938 | 6.00 | 251 |
| | Our | 608 | 0.02 | 176 |

It can be seen from Table 1 that the cost of storage and computing of the mapping results of the present application is much lower than that of LTBC and high-precision models. In the present application, photo-level textures are generated for the simplified model, and compared with the high-precision model, the simplified model has much lower storage and computing costs, and can have a similarly or superiorly visual effect in some regions.

In the present application, for quantitative evaluation on the results of image stitching, some planes with high texture quality and a large number of matching lines are selected from the two scenes, and quantification is then performed using collinearity quantitative evaluation standard. This standard is used to evaluate whether the straight line structure of the source image is aligned with the matching straight line structure feature in the target image after image stitching. In the present application, two evaluation standards are used. The first evaluation standard is distance error term, which represents the average distance between the endpoint of the straight line and the matching straight line after the image distortion. This standard is shown in equation (4), where pₛ^{j} and pₑ^{j} are the endpoints of the straight line in the source image. The equation represents a distance from the endpoint of the straight line of the source image to its matching straight line.

$${E}_{dis} = \sqrt{\frac{1}{L} {\sum }_{j = 1}^{L} {‖ \frac{dis ( {l}_{j}^{′} , {p}_{s}^{j} ) + dis ( {l}_{j}^{′} , {p}_{e}^{j} )}{2} ‖}^{2}} ;$$

(4) where

E_{dis} represents a distance from a mesh vertex to a matching straight line after moving, which is used to measure whether the mesh edge is aligned with the matching straight line after the mesh distortion, dis(l′ⱼ, pₛ^{j}) represents a distance from an endpoint pₛ^{j} to a straight line l′ⱼ, and dis(l′ⱼ, pₑ^{j}) represents a distance from the endpoint pₑ^{j} to a straight line l′ⱼ.

The second evaluation standard is straight line direction error, which represents a direction difference between a straight line on a source image and its matching straight line after adaptive mesh deformation. The second evaluation standard is shown in equation (5):

$${E}_{dir} = \sqrt{\frac{1}{L} {\sum }_{j = 1}^{L} {‖ sin ( θ ) ‖}^{2}} ;$$

(5) where

E_{dir} represents an angle difference between a distorted mesh edge and a matching straight line, and indicates that a smaller angle between the distorted mesh edge and the matching straight line is better; and θ represents an angle between a straight line feature on a source image and its matching straight line.

In the present application, based on the such standard, the average of the two errors is calculated for each source view and target view on a selected plane and compared with those generated based on methods of Liao et al. and Jia et al. It can be seen from the comparison result shown in FIG. 2 that because compared with the uniform mesh, the adaptive mesh with feature of each straight line individually controllable so as to align each straight line with the matching straight line, the method of the present application is superior to the other two methods in test of the scenes of a technology building and a telecommunication building.

TABLE 2
Comparison of straight
line feature alignment error

| Scenario | Method | E_{dis} | E_{dis} |
|---|---|---|---|
| Technology | Liao | 1.06089 | 0.01142 |
| building | Jia | 2.60402 | 0.01350 |
| | Our | 0.96814 | 0.00568 |
| Tele- | Liao | 1.04808 | 0.00952 |
| communication | Jia | 1.35084 | 0.01209 |
| building | Our | 0.37151 | 0.00102 |
| L7 | Liao | 4.07870 | 0.01715 |
| | Jia | 2.99699 | 0.02584 |
| | Our | 3.62430 | 0.01459 |

In the present application, the image texture generation method is compared with the existing texture mapping method, and the result obtained through the image texture generation method is compared with that of the high-precision model. The present application has the visual effect comparable to that of the high-precision model, and further have the storage and computing overheads reduced greatly. As compared with the previous texture mapping method, the straight line structure features of the building are remained without seams in the texture result in the present application, and the present application is advantageous in the storage overheads of models.

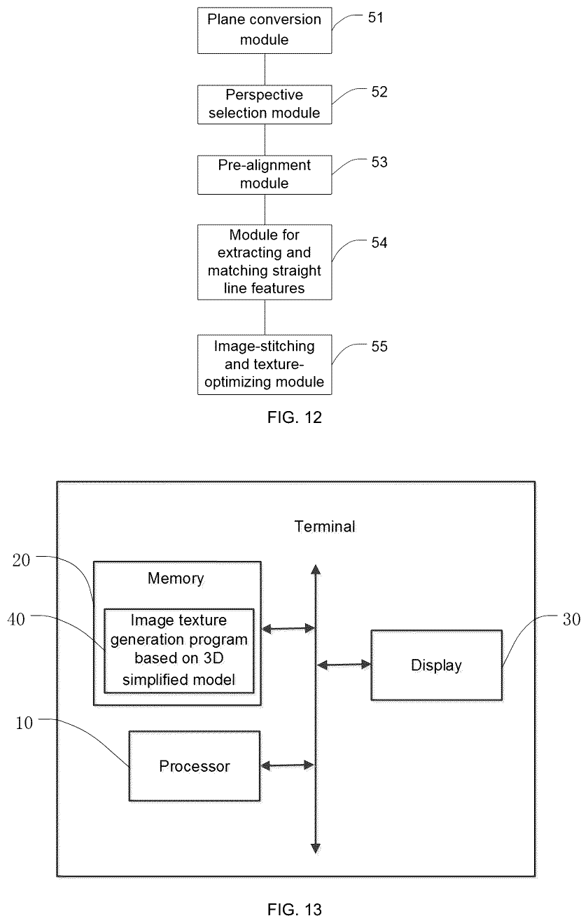

Further, as shown in FIG. 12, based on the image texture generation method based on the 3D simplified model, the present application further provides an image texture generation system based on a 3D simplified model, including:
a plane conversion module 51, configured to obtain a 3D simplified model, perform surface subdivision processing on the 3D simplified model, and convert a plane in the 3D simplified model into dense triangular patches, where the triangular patch is taken as a basic unit of the plane;
a view selection module 52, configured to select a group of candidate views for each plane, calculate view quality of each candidate view of each plane under a current condition using greedy algorithm, and select out locally optimal views after sorting, to generate an optimal view set;
a pre-alignment module 53, configured to select a view with the highest quality as a target image from the optimal view set of each plane, where the other views serve as source images, calculate a homography matrix H from the source image to the target image, perform view distortion on the source image through the homography matrix, and transform the source image into a camera space of the target image, so as to generate a rough result of image stitching;
a module 54 for extracting and matching straight line features, configured to extract straight line features from the source image and target image and match the straight line features, and perform local fine-tuning on the source image via an adaptive mesh, so as to align straight line features; and
an image-stitching and texture-optimizing module 55, configured to control image distortion using the adaptive mesh, perform graph cutting and Poisson editing to mix the images after the source images are distorted, eliminate seams in image stitching, and perform image stitching and texture optimizing to generate a photo-level texture for the 3D simplified model.

Further, as shown in FIG. 13, based on the foregoing image texture generation method and system based on the 3D simplified model, the present application further provides a terminal. The terminal includes a processor 10, a memory 20, and a display 30. FIG. 13 shows only some of the terminal components, but it should be understood that it is not required that all components shown in the embodiments can replace more or fewer component implemented

The memory 20 may be an internal memory unit of the terminal in some embodiments, such as a hard disk or memory of the terminal. In other embodiments, the memory 20 may further be an external storage device of the terminal, such as a plug-in hard disk equipped on the terminal, a smart memory card (Smart Media Card, SMC), a secure digital (Secure Digital, SD) card, or a flash memory card (Flash Card). Further, the memory 20 may further include both an internal memory unit of the terminal and an external storage device. The memory 20 is used to store application software installed on the terminal and various data, such as program code for installing terminal. The memory 20 may be alternatively used to temporarily store data that has been output or will be output. In some embodiments, the memory 20 stores an image texture generation program 40 based on a 3D simplified model. The image texture generation program 40 based on the 3D simplified model is capable of being executed by a processor 10, thereby implementing the image texture generation method based on the 3D simplified model.

In some embodiments, the processor 10 may be a central processing unit (Central Processing Unit, CPU), a microprocessor or other data processing chips for running program codes stored in the memory 20 or processing data, for example, is used to implement the image texture generation method based on the 3D simplified model.

In some embodiments, the display 30 may be an LED display, a liquid crystal display, a touch-sensitive liquid crystal display, an OLED (Organic Light-Emitting Diode, Organic Light-Emitting Diode) touch panel, and the like. The display 30 is used to display information on the terminal and a visualized user interface. The components 10-30 of the terminal communicate with each other via a system bus.

In some embodiments, when the processor 10 executes the image texture generation program 40 based on a 3D simplified model in the memory 20, the steps of the image texture generation method based on the 3D simplified model are performed.

The present application further provides a computer-readable storage medium. The computer-readable storage medium stores an image texture generation program based on a 3D simplified model, where when the image texture generation program based on a 3D simplified model is executed by the processor, the steps of the image texture generation method based on a 3D simplified model are implemented.

It should be noted that in the specification, terms “include”, “comprise”, or any other variants thereof are intended to cover non-exclusive inclusion, such that a process, method, article, or terminal including a series of elements includes not only those elements but also other elements not explicitly listed, or elements inherent to such a process, method, article, or terminal. Without more restrictions, the elements defined by the sentence “including a . . . ” do not exclude the existence of other identical elements in a process, method, article, or terminal including the elements.

Certainly, those of ordinary skill in the art can understand that all or some of the processes in the methods of the above embodiments can be implemented by instructing related hardware (such as processors or controllers) through computer programs. The program can be stored in a computer-readable storage medium, and when executed, the program can include the processes of the foregoing method embodiments. The computer-readable storage medium described herein may be a memory, a magnetic disk, an optical disk, and the like.

It should be understood that the application of the present application is not limited to the foregoing examples, and those skilled in the art can make improvements or transformations according to the above descriptions, and all these improvements and transformations should belong to the protection scope of the appended claims of the present application.

What is claimed is:

1. An image texture generation method based on a 3D simplified model, comprising:
obtaining a 3D simplified model, performing surface subdivision processing on the 3D simplified model, and converting a plane in the 3D simplified model into dense triangular patches, where the triangular patch is taken as a basic unit of the plane;
selecting a group of candidate views for each plane, calculating view quality of each candidate view of each plane under a current condition using greedy algorithm, and selecting out locally optimal views after sorting, so as to generate an optimal view set;
selecting a view with highest quality as a target image from the optimal view set of each plane, while other views serve as source images, calculating a homography matrix from the source image to the target image, performing view distortion on the source image through the homography matrix, and transforming the source image into a camera space of the target image, so as to generate a rough result of image stitching;
extracting straight line features from the source image and target image and matching the straight line features, and performing local fine-tuning on the source image via an adaptive mesh, so as to align the straight line features; and
controlling image distortion using the adaptive mesh, performing graph cutting and Poisson editing to mix the images after the source images are distorted, eliminating seams in image stitching, and performing image stitching and texture optimizing to generate a photo-level texture for the 3D simplified model.

2. The image texture generation method based on a 3D simplified model according to claim 1, wherein after the obtaining of a 3D simplified model, performing surface subdivision processing on the 3D simplified model, and converting a plane in the 3D simplified model into dense triangular patches, the triangular patch is taken as a basic unit of the plane, further comprises:
if a single triangular patch satisfies any one of preset conditions, considering that the triangular patch is invisible in view, and filtering out the invisible triangular patch, the preset conditions comprise:
only a back of a triangular patch is visible in view;
an angle between a vector from a center of a triangular patch to a view and a patch normal vector is greater than 75 degrees;
a triangular patch exceeds an image boundary after being projected into the image space;
a triangular patch occludes a simplified model in view; and
a triangular patch occludes a dense model in view.

3. The image texture generation method based on a 3D simplified model according to claim 1, wherein the selecting of a group of candidate views for each plane, calculating view quality of each candidate view of each plane under a current condition using greedy algorithm, and selecting out locally optimal views after sorting, so as to generate an optimal view set, comprises:
calculating a photometric consistency coefficient for each candidate view using a mean shift method, calculating an average color value of each candidate view after filtering, finding a mean and covariance of the average color values of the views, calculating a consistency value of each view using a multivariate Gaussian kernel function, and deleting the view of which the consistency value is lower than a first preset size from the candidate views until a maximum covariance of the average color values is lower than a second preset size;
taking the remaining candidate views as a group of views with highest consistency, and computing a photometric consistency value for each view of the plane according to a mean and covariance of the views with the highest consistency, a larger photometric consistency value represents a higher photometric consistency of view; and
the view quality is calculated according to the following equation:
G( [symbol] ᵢ, [symbol] ᵢ^{t})=D( [symbol] ᵢ, [symbol] ᵢ^{t})·C( [symbol] ᵢ, [symbol] ᵢ^{t})·N( [symbol] ᵢ, [symbol] ᵢ^{l}),
D( [symbol] ᵢ, [symbol] ᵢ^{t}) represents an average gradient magnitude; C( [symbol] ᵢ, [symbol] ᵢ^{l}) represents a photometric consistency coefficient; N( [symbol] ᵢ, [symbol] ᵢ^{t}) represents an angle between a sight line and a normal line; [symbol] ᵢ represents each view; and [symbol] ᵢ^{t} represents a region covered by a specified color boundary in each texture block; and
according to view quality of each view, selecting out the locally optimal views after sorting, so as to generate the optimal view set.

4. The image texture generation method based on a 3D simplified model according to claim 3, wherein information considered when the view quality is calculated comprises: view clarity, photometric consistency, angle between a plane and a sight line, and completeness of plane texture information contained by a view.

5. The image texture generation method based on a 3D simplified model according to claim 3, wherein the extracting of straight line features from the source image and target image and matching the straight line features, and performing local fine-tuning on the source image via an adaptive mesh, so as to align the straight line features, comprises:
extracting a plurality of local straight line features from the source image and target image, filtering out small and dense straight lines, and fusing local straight line features into global straight line features;
comparing the global straight line features of the source image and the target image, and when an angle between candidate straight lines for matching and a distance from an endpoint to the straight line are less than set thresholds, considering that two straight lines match; and
triangulating the global straight line features to generate an adaptive mesh based on straight line features for all views in the plane, and using the adaptive mesh to perform local fine-tuning on the images.

6. The image texture generation method based on a 3D simplified model according to claim 1, wherein the controlling of image distortion using the adaptive mesh, and the performing graph cutting and Poisson editing to mix the images after the source images are distorted comprise:
setting the adaptive mesh as an adaptive triangular mesh;
controlling distortion of the adaptive triangular mesh using the following energy equation:
E(\hat{V})=λₐEₐ(\hat{V})+λₗEₗ(\hat{V})+λᵣEᵣ(\hat{V});
(\hat{V}) represents a vertex position of the distorted adaptive triangular mesh; Eₐ(\hat{V}) represents an alignment item for a straight line feature, which is used to show a moving distance of the vertex (\hat{V}); Eₗ(\hat{V}) represents a straight line feature reservation item, which is used to ensure linearity of the straight line feature before and after image distortion; Eᵣ(\hat{V}) represents a regular term, which is used to prevent an offset of the vertex from being excessively large; and λₐ, λₗ, and λᵣ represent weights of Eₐ(\hat{V}), Eₗ(\hat{V}), and Eᵣ(\hat{V}) respectively;
substituting points of the adaptive mesh of the source image into a straight line equation of a matched target image, to obtain an alignment error of matched straight lines between the source image and the target image, straight line equation is as follows:
$${E}_{a} ( \hat{V} ) = {\sum }_{t = 1}^{M} {‖ {a}_{t} \hat{x} + {b}_{t} \hat{y} - {c}_{t} ‖}^{2} = {‖ {W}_{a} \hat{V} ‖}^{2} ;$$
\hat{x} and ŷ represent vertex coordinates; aₜ, bₜ, and cₜ represent three parameters of the straight line equation; M represents a quantity of matched straight-line pairs; and Wₐ represents a matrix; and
for all segmented straight line features, Eₗ(\hat{V}) is expressed using the following equation:
Eₗ(\hat{V})=Σg=1^{N}Σₖ₌₁^{J}^{_{g}}⁻¹∥((\hat{p}ₖ₊₁^{g})−(\hat{p}ₖ^{g}))·\vec{n}^{g}∥²=∥Wₗ\hat{V}∥²;
N represents a quantity of segmented global straight lines; J_{g} represents a quantity of points on a global straight line; g represents a g th matched straight line feature; k represents a k th point on a global straight line; \vec{n}_{g} represents a normal vector of a global straight line; and Wₗ represents a coefficient in matrix form; and
traversing all triangular patches in the adaptive triangular mesh, calculating an affine transformation matrix of distorted triangular patches for triangular patches before distortion, performing affine transformation on an image region in which the triangular patches are located, stitching all transformed triangular image fragments into a new image, and mixing the distorted new image with the target image through graph cutting and Poisson editing.

7. The image texture generation method based on a 3D simplified model according to claim 6, wherein the texture optimizing comprises:
for a texture block of each source image, extracting an overlapping region between the texture block of each source image and a target texture block; and
transforming an overlapping region of target texture blocks as well as the texture block of the entire source image into an HSV space, calculating a histogram distribution for a v channel, performing histogram matching between a v channel of the source image and a v channel of the overlapping region of the target regions, and transferring a luminance distribution of the overlapping region to the texture block of the entire source image.

8. An image texture generation system based on a 3D simplified model, comprising:
a plane conversion module configured to obtain a 3D simplified model, perform surface subdivision processing on the 3D simplified model, and convert a plane in the 3D simplified model into dense triangular patches, where the triangular patch is taken as a basic unit of the plane;
a view selection module configured to select a group of candidate views for each plane, calculate view quality of each candidate view of each plane under a current condition using greedy algorithm, and select out locally optimal views after sorting, to generate an optimal view set;
a pre-alignment module configured to select a view with the highest quality as a target image from the optimal view set of each plane, other views serve as source images, calculate a homography matrix H from the source image to the target image, perform view distortion on the source image through the homography matrix, and transform the source image into a camera space of the target image, so as to generate a rough result of image stitching;
a module for extracting and matching straight line features configured to extract straight line features from the source image and target image and match the straight line features, and perform local fine-tuning on the source image via an adaptive mesh, so as to align straight line features; and
an image-stitching and texture-optimizing module configured to control image distortion using the adaptive mesh, perform graph cutting and Poisson editing to mix the images after the source images are distorted, eliminate seams in image stitching, and perform image stitching and texture optimizing to generate a photo-level texture for the 3D simplified model.

9. A terminal, comprising: a computer readable storage medium, a processor, and an image texture generation program based on a 3D simplified model, the image texture generation program being stored on the computer readable storage medium and capable of running on the processor, when the image texture generation program based on a 3D simplified model is executed by the processor, the steps of the image texture generation method based on a 3D simplified model according to claim 1 are implemented.
